(19) United States
(12) Patent Application Publication
(10) Pub. No.: US 2026/0330451 A1
(43) Pub. Date: Oct. 22, 2026

(54) PROGRAMMABLE DIGITAL ASSET TRANSACTION ORCHESTRATION USING CRYPTOCURRENCY NETWORKS

(71) Applicant: Circle Internet Group, Inc., New York, NY (US)

(72) Inventors: Fausto Moreno Bombareli, New York, NY (US); Nikhil Chandhok, New York, NY (US); Yue Hu, New York, NY (US); Sumanth Subhash Jinagouda, New York, NY (US); Sunil Sharma, New York, NY (US); Barry Torsney, New York, NY (US); Joanna Marathakis, New York, NY (US); Hao Min, New York, NY (US); Yunfei Zhao, New York, NY (US); Junxiang Du, New York, NY (US); Edward Bao, New York, NY (US)

(21) Appl. No.: 19/654,229

(22) Filed: Apr. 21, 2026

Related U.S. Application Data
(60) Provisional application No. 63/792,229, filed on Apr. 21, 2025.

(51) Int. Cl. G06Q 20/38; G06Q 20/06; G06Q 20/36

(52) U.S. Cl. CPC G06Q 20/381; G06Q 20/0655; G06Q 20/36; G06Q 2220/00

(57) ABSTRACT

This specification describes systems, methods, devices, and other techniques relating to a protocol layer defining a transaction network for internet-based settlement systems including cryptocurrency networks. More particularly, implementations of the present disclosure are directed to a transaction network that functions as a coordination layer to bring enterprises together in a compliant, seamless, and programmable framework to orchestrate transactions in fiat currencies and digital assets.

### CROSS-REFERENCE TO RELATED APPLICATIONS

This application claims priority to and the benefit of U.S. Prov. App. No. 63/792,229, filed on Apr. 21, 2025, which is expressly incorporated herein by reference for all purposes.

### TECHNICAL FIELD

This specification relates generally to digital assets and more particularly to a protocol layer for internet-based settlement systems including cryptocurrency networks.

### BACKGROUND

The development of distributed ledger technology has enabled a multitude of digital transactions not available in the pre-digital, pre-Internet world. For example, distributed ledger technology enables users to hold digital assets as stores of value and mediums of exchange with immutability and traceability. In general, a digital asset can be described as a virtual store of value that leverages a distributed ledger to store, record, and validate transactions. An example digital asset includes cryptocurrencies. Distributed ledgers can be referred to as blockchains or chains.

### SUMMARY

This specification describes systems, methods, devices, and other techniques relating to a protocol layer defining a transaction network for internet-based settlement systems including cryptocurrency networks. More particularly, implementations of the present disclosure are directed to a transaction network that functions as a coordination layer to bring enterprises together in a compliant, seamless, and programmable framework to orchestrate transactions in fiat currencies and digital assets.

In general, innovative aspects of the subject matter described in this specification can include actions of receiving, by a transaction network, a first set of transaction data, and determining that the first set of transaction data is associated with a first type of transaction, and in response, transmitting, by the transaction network, at least a portion of the first set of transaction data to a beneficiary entity associated with a quote identifier provided in the first set of transaction data, and receiving, by the transaction network, a transaction confirmation, and in response: receiving an on-chain send request, returning on-chain transaction data for signature, receiving a signed transaction, broadcasting the signed transaction, and receiving a transaction confirmation message confirming that a transaction has been executed, the transaction at least partially comprising converting tokens of a cryptocurrency to a first amount of a first fiat currency. Other implementations of this aspect include corresponding systems, apparatus, and computer programs, configured to perform the actions of the methods, encoded on computer storage devices.

These and other implementations can each optionally include one or more of the following features: the first set of transaction data includes beneficiary data that is representative of the beneficiary entity of a plurality of beneficiary entities; the transaction further includes converting an amount of a second fiat currency to the tokens of the cryptocurrency; actions further include receiving, by the transaction network, a second set of transaction data, and determining that the second set of transaction data is associated with a second type of transaction, and in response, transmitting, by a minting account of the transaction network, a unique identifier associated with the second set of transaction data, receiving an amount of a fiat currency associated with the unique identifier, providing a set of tokens of the cryptocurrency to a sub-wallet associated with the transaction network within the cryptocurrency network, receiving, by the transaction network, an address identifier associated with an external wallet within the cryptocurrency network, and transferring, by the transaction network, an on-chain payout of at least a sub-set of the set of tokens of the cryptocurrency to the external wallet; the transaction network executes one or more regulatory checks associated with an entity that owns the external wallet, and the on-chain payout is executed at least partially in response to determining compliance with the one or more regulatory checks; the transaction network executes the on-chain payout in response to an application programming interface (API) call comprising the address identifier; actions further include receiving, by the transaction network, a third set of transaction data, and determining that the third set of transaction data is associated with a third type of transaction, and in response, depositing, by the transaction network, a set of tokens of the cryptocurrency to a sub-wallet associated with the transaction network within the cryptocurrency network, and receiving, by the transaction network, a withdraw request associated with an entity identifier, and in response, burning at least a sub-set of the set of tokens of cryptocurrency within the cryptocurrency network; actions further include receiving the set of tokens of the cryptocurrency from an on-chain account within the cryptocurrency network, wherein the transaction network executes one or more regulatory checks associated with an entity that is associated with the on-chain account, and deposits the set of tokens of the cryptocurrency to the sub-wallet at least partially in response to the one or more regulatory checks; and actions further include, in response to depositing, by the transaction network, the set of tokens of the cryptocurrency to a sub-wallet, transmitting a deposit success message to an enterprise system, and receiving, by the transaction network, a request to add an external account, and in response, returning the external identifier to the enterprise system.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example environment in accordance with implementations of the present disclosure.

FIG. 2 depicts a conceptual architecture in accordance with implementations of the present disclosure.

FIGS. 3A-3C depict respective transaction flows that can be executed using the transaction network of the present disclosure.

FIG. 4 depicts a flowchart of an example process that can be executed in accordance with implementations of the present disclosure.

Like reference numbers and designations in the various drawings indicate like elements.

### DETAILED DESCRIPTION

This specification describes systems, methods, devices, and other techniques relating to a protocol layer defining a transaction network for internet-based settlement systems including cryptocurrency networks. More particularly, implementations of the present disclosure are directed to a transaction network that functions as a coordination layer to bring enterprises together in a compliant, seamless, and programmable framework to orchestrate transactions in fiat currencies and digital assets.

To provide context for the subject matter of the present disclosure, and as introduced above, users can hold digital assets as stores of value and mediums of exchange. In general, a digital asset can be described as a virtual store of value that leverages a peer-to-peer network to store, record, and validate transactions. The peer-to-peer network can maintain a distributed ledger (e.g., blockchain), which can be described as a decentralized database that immutably stores transactions across the peer-to-peer network. Example digital assets can include, without limitation, cryptocurrencies (e.g., stablecoins), non-fungible tokens (NFTs), security tokens, tokenized money market funds (T-MMF), and the like (e.g., tokenized government obligations).

In some examples, a cryptocurrency can be described as a digital currency that uses cryptography to secure transactions that are recorded in a distributed ledger (e.g., blockchain). In some examples, a stablecoin can be described as a cryptocurrency having a value that is tied (pegged) to the value of a real-world, non-digital asset, such as a fiat currency, a commodity, or a financial instrument. Stablecoins are absent the volatility of other cryptocurrencies and, as such, are a useful medium of exchange. Example stablecoins include, without limitation, USDC™ and EURC^{TM}. Generally, stablecoins can be used as digital cash within global digital asset markets and decentralized finance (DeFi), but also provide a foundation for payments and money movement on the Internet.

Implementations of the present disclosure are described in further detail herein with reference to example peer-to-peer networks (also referred to herein as chain networks), each maintaining a respective chain. Some example peer-to-peer networks can each be described as an Ethereum-compatible network. Ethereum can be described as a decentralized computing infrastructure that executes a virtual machine, referred to as the Ethereum virtual machine (EVM), to execute transactions on a chain. The EVM can be described as a global singleton and operates as a single-instance computer, globally across nodes of the peer-to-peer network. That is, each node in the network executes a local copy of the EVM to execute transactions on the chain. The chain of the peer-to-peer network records the changing state of the EVM as transactions are processed. While Ethereum is referenced herein for purposes of illustration, it is contemplated that implementations of the present disclosure can be realized using any appropriate peer-to-peer network (e.g., networks that provide on-chain computing; EVM-compatible chains). Example peer-to-peer networks can include, without limitation, Arbitrum, Avalanche, and Base, among several others, each of which is EVM-compatible. It is contemplated, however, that implementations of the present disclosure can be realized on non-EVM peer-to-peer networks, such as Solana, Aptos, Sui, and the like.

In general, tokens of a digital asset can be generated using a minting process. In some examples, a token (also referred to as a digital token) can be described as immutable, computer-readable code that represents a digital asset and is stored in a distributed ledger. Minting can generally be described as generating tokens of a digital asset through execution of cryptographic transactions within a network and recording the transactions in a blockchain maintained within the network. In some examples, minting is executed through a minting function of a smart contract (minter) that is executed within the network. On the other hand, tokens of a cryptocurrency can be permanently removed from circulation within a network using a burning process. Burning can generally be described as permanently removing tokens of a cryptocurrency from circulation through execution of cryptographic transactions within a network and recording the transactions in a blockchain maintained within the network. In some examples, burning is executed through a burning function of a smart contract (burner) that is executed within the network. Smart contracts can be described as programs that are executed on-chain and are each provided as a collection of code (functions) and data (state) that resides at a specific address on the chain.

To provide further context for implementations of the present disclosure, the global digital economy is interconnected. Unlike almost every other sector of the economy, the infrastructure that underpins value movement remains stuck in the pre-Internet era. Until very recently, delivering a “money protocol” for sending value in a fully native digital form across the internet was not truly possible. Society for Worldwide Interbank Financial Telecommunications (SWIFT) and Automated Clearing House (ACH) (and similar protocols that emerged around the world), two key components of today’s fragmented global transactions landscape, were established in 1973 and 1972, respectively. Recent developments (such as Single Euro Payments Area (SEPA) in the eurozone, and national real-time payment systems like the instant payment ecosystem (PIX) in Brazil and Unified Payments Interface (UPI) in India) have improved domestic transaction speed. However, these still lack global interoperability and scale and do not take advantage of the openness and extensibility of programmable digital assets built on open blockchain networks (e.g., cryptocurrency networks).

Enterprises and individuals around the world pay the price of relying on this legacy transactions infrastructure. It has been reported that the global transactions industry revenue has surpassed $2.4 trillion annually. Much of this “revenue” comes in the form of fees extracted by traditional transaction intermediaries from both senders and receivers—effectively functioning as a tax on global commerce and households. For example, bank wire transfers can cost up to $50 per transaction, rendering small-value payments impractical. In one estimate, in the second quarter of 2024, the global average cost of sending $200 was 6.65%. Additionally, the need to convert across a wide array of fiat currencies adds to these challenges by introducing expensive foreign exchange (FX) fees and price volatility.

The lengthy settlement processes inherent in the correspondent banking system also impose additional costs. For importers and buyers, having to wait days for an outgoing payment to clear can hamper their cash position and drive complexity in liquidity planning. For exporters and sellers, unpredictable multi-day settlement windows mean they must fund more of their short-term operations with costly borrowed working capital. Remittance recipients who depend on cross-border transfers for food, shelter, and other basic necessities risk seeing critical income eroded by traditional intermediaries while enduring lengthy payment delays, and in some cases, the inherent risk of handling cash in environments susceptible to physical crime.

While the Internet has revolutionized nearly every aspect of global commerce over the last several decades, the way value moves is still rooted in fragmented legacy networks that lack transparency, efficiency, and a path for open innovation. While some governments have implemented successful national real-time payment systems, these solutions do not scale globally and offer limited extensibility for developers. In the half century since the appearance of SWIFT and ACH, global communications have advanced to connect people instantly, across the world. Billions of people can now stream movies on handheld mobile phones while riding the subway, access the sum of human knowledge instantly at virtually no cost, and buy or sell nearly any product from every corner of the world.

In view of the foregoing, implementations of the present disclosure are directed to a protocol layer that defines a transactions network (referred to as CPN herein) functioning as a coordinator to bring financial institutions together in a compliant, seamless, and programmable framework to orchestrate transactions in fiat currencies and digital assets. As described in further detail herein, the CPN of the present disclosure is built on open, public blockchain infrastructure. In hand with digital assets, such as stablecoins, the CPN provides a powerful foundation for builders to launch on-chain applications that use networks to move value seamlessly.

In further detail, the CPN of the present disclosure enables collaboration with enterprises, such as global banks, payment service providers, and other digital asset native financial institutions. In this context, the CPN is provided as a protocol layer in a comprehensive, open and internet-based settlement system with digital assets, such as stablecoins, at its core. By connecting open platforms with global scale and fewer intermediaries, the CPN of the present disclosure enables value to move in a way that is not possible with closed, legacy networks.

The CPN enables, for example, billions of individuals and tens of millions of businesses to use money and access other financial services in ways that are as transformative as these other global Internet utilities. The CPN reduces technical complexity and minimizes operational challenges that have thus far prevented the adoption of digital assets, such as stablecoins, into mainstream payments and commerce, paving the way for a more efficient, inclusive, innovative and transparent financial ecosystem.

In an example use case, the CPN enables suppliers to receive cross-border payments almost instantly and cheaply, leveraging a modern platform that supports regulatory compliance, while providing crucial working capital to keep global supply chains running smoothly. In some examples, small merchants will be able to be paid in near-real-time without significant fees eating up several percent of sales. In some examples, global merchants can grow by taking payments directly from customers in new markets. Remittance beneficiaries will be able to receive a greater share of every dollar, for example, sent home by family and friends, amplifying purchasing power for people who need it most.

The CPN of the present disclosure overcomes a range of technical, operational, and financial challenges that have prevented enterprises from unlocking the full benefits of digital assets, such as stablecoins, for example, to date. Senders will be able to initiate payments in fiat currency or stablecoins, for example, with both enterprises and individual recipients able to keep stablecoins or convert stablecoins to fiat currency upon receipt. Borderless payments that are nearly instant and nearly free can become a widespread option.

The CPN is a transparent, secure, scalable infrastructure for financial institutions to better serve their business and individual customers. The CPN offers the ability to unlock these efficiencies without sacrificing compliance being built on a rigorous governance framework that requires participating financial institutions to meet global Anti-Money Laundering and Countering the Financing of Terrorism (AML/CFT) standards, along with economic sanctions requirements. With a global network of financial institutions, robust security, and strong transparency, transactions on the CPN will be secure, efficient, and reliable.

In accordance with implementations of the present disclosure, the CPN does not move funds directly. Rather, the CPN serves as a marketplace of financial institutions and acts as a coordination layer that orchestrates global value movement and the seamless exchange of information. A network provider (i.e., one or more entities providing the CPN) defines the CPN protocol and provides application programming interfaces (APIs), developer software development kits (SDKs), and smart contracts to orchestrate global value movement using digital assets. Through this infrastructure, the CPN enables financial institutions to foster seamless, trusted interactions within the CPN and extend this value proposition to their base of customers.

The CPN is a space where banks, payment companies, on- and off-ramp providers, app developers, and other stablecoin issuers, for example, can innovate together to deliver greater value and improved experiences for customers. Built on open, public blockchain infrastructure, the CPN and stablecoins provide a powerful foundation for builders to launch on-chain applications that use these networks to move money seamlessly.

More particularly, the CPN provides the building blocks for innovators and builders to develop user experiences (UXs) and support a wide range of payment use cases. Over time, builders will be able to create a vibrant ecosystem of modules and application services on top of the CPN—building a third-party marketplace of capabilities for participants and end users of the CPN to benefit from, and unlocking a new and powerful distribution platform for fintech developers.

With regard to entities, such as businesses, importers, exporters, merchants, and other enterprises can leverage CPN-enabled financial institutions to eliminate significant costs and friction, strengthen global supply chains, optimize treasury operations, and reduce reliance on costly borrowed working capital. With regard to individuals, such as remittance senders and recipients, content creators, and other individuals that tend to receive small value payments will realize more value, and the financial institutions that use the CPN will be able to deliver these improved services faster and with less expense and complexity. With regard to builders, such as banks, payment companies, and other providers can leverage the CPN services to develop innovative payments use cases, utilizing the programmability of stablecoins, SDKs, and smart contracts to deliver a thriving ecosystem. Over time, this can unlock the full potential of stablecoin payments for businesses and individuals alike. Additionally, third-party developers and enterprises can introduce value-added services, further expanding the network’s capabilities.

Accordingly, and as described herein, implementations of the present disclosure provide an alternative to traditional protocols and infrastructures for transactions between entities and provide technical improvements over such approaches. For example, the CPN of the present disclosure provides global interoperability and scale and enables use of the openness and extensibility of programmable digital assets built on open blockchain networks (e.g., cryptocurrency networks). As another example, the CPN of the present disclosure reduces costs, settlement times, and eliminates intermediaries, as well as providing technically secure, resource-efficient, and versatile transaction options. As described in detail herein, transaction flows are executed programmatically through the CPN using smart contracts—minimizing manual steps and enabling intelligent, cross-border machine-to-machine transactions.

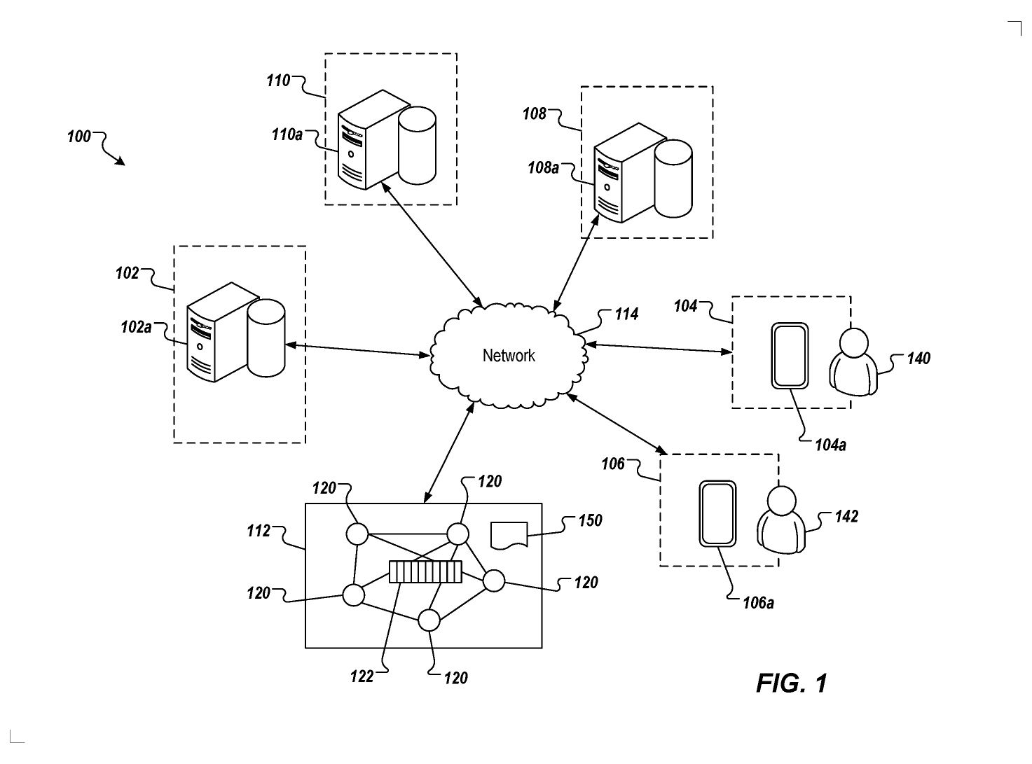

FIG. 1 is an example environment 100 that can be used to execute implementations of the present disclosure. In some examples, the example environment 100 enables entities to participate in a cryptographic network for secure transactions. The example environment 100 includes a provider system 102, a user system 104, a user system 106, an enterprise system 108, an enterprise system 110, a cryptographic network 112, and a network 114. In some examples, the network 114 includes a local area network (LAN), wide area network (WAN), the Internet, or a combination thereof, and connects web sites, user devices (e.g., computing devices), and back-end systems. In some examples, the network 114 can be accessed over a wired and/or a wireless communications link.

In the example use case, the cryptographic network 112 can be provided as a cryptographic network that enables a provider of a cryptocurrency (referred to herein as a minting entity, or provider entity) to distribute tokens of a cryptocurrency to enterprises and/or users and that enables enterprises and/or users to execute transactions that use the cryptocurrency. The cryptographic network 112 can be described as a peer-to-peer network of nodes 120 and transactions related to the cryptocurrency are immutably stored within a blockchain 122. For example, the blockchain 122 is a distributed ledger that is updated and stored across multiple nodes within the cryptographic network 112. Although the cryptographic network 112 is depicted separately from the network 114, it is contemplated that at least a portion of the cryptographic network 112 can be provided within the network 114 (e.g., as nodes that are distributed across the Internet).

In the depicted example, the provider system 102 includes a respective computing device 102a, which can, for example, represent one or more servers. In some examples, the provider system 102 can be operated by or on behalf of a provider entity (minting entity) in accordance with implementations of the present disclosure. In some examples, the provider entity mints and distributes a cryptocurrency, such as a stablecoin (e.g., USDC^{TM}). In this example, the computing device 102a is operated by the provider entity to mint tokens of the cryptocurrency and distribute tokens to users and/or enterprises, as well as execute transactions. Transactions associated with the cryptocurrency are recorded in the blockchain 122 of the cryptographic network 112. In some examples, the computing device 102a can function as a node of the cryptographic network 108.

In the depicted example, the user systems 104, 106 each includes a respective computing device 104a, 106a. In some examples, the computing device 104a, 106a can include, without limitation, a server, a desktop computer, a laptop computer, a tablet computing device, and a smartphone. In some implementations, a user 140, 142 uses the computing device 104a, 106a, respectively, to execute transactions within the network 114 and/or the cryptographic network 112. In some examples, transactions executed in the cryptographic network 112 are immutably recorded in the blockchain 120 of the cryptographic network 112. Example transactions can include, without limitation, purchasing tokens of a cryptocurrency from the provider entity, transferring tokens of cryptocurrency, and receiving tokens of cryptocurrency.

In the depicted example, the enterprise systems 108, 110 each includes a computing device 108a, 110a. In some examples, the computing device 108a, 110a can include, without limitation, a server, a desktop computer, a laptop computer, a tablet computing device, and a smartphone. In some implementations, a commercial entity (e.g., payment service provider (PSP)) uses the computing device 108a, 110a to execute transactions within the network 114 and/or the cryptographic network 112. In some examples, transactions executed in the cryptographic network 112 are immutably recorded in the blockchain 120 of the cryptographic network 112. Example transactions can include, without limitation, receiving tokens of a cryptocurrency and transferring tokens of a cryptocurrency.

In accordance with implementations of the present disclosure, the CPN of the present disclosure is provisioned within the cryptocurrency network 112 and the network 114. As described in further detail herein, the CPN of the present disclosure is provided as a protocol layer that orchestrates transactions using digital assets, such as cryptocurrencies, through a suite of technology services and protocols.

Further, transactions (or parts thereof) provided through the CPN of the present disclosure can be performed using public-key cryptography that uses, for each entity (e.g., user, enterprise, provider entity), a matched pair of keys, namely, a private key that is kept secret and a public key that can be shared with others. The private key and the public key are mathematically related, but the private key cannot feasibly be derived from the public key. In cryptographic networks, such as cryptocurrency networks, digital signatures associated with transactions are generated. For example, a user creates a transaction (or a portion thereof) and uses their private key to generate a digital signature on the transaction data. The digital signature proves that the holder of the private key (i.e., the user) authorized the transaction and that the transaction data has not been altered. Anyone on the cryptographic network can use the public key of the user to verify the signature. If verification succeeds, it is determined that the transaction was signed by the corresponding private key and that the signed contents remain intact. In this way, the private key is used to establish authenticity and control, while the public key allows everyone else to verify that authenticity without learning the private key itself.

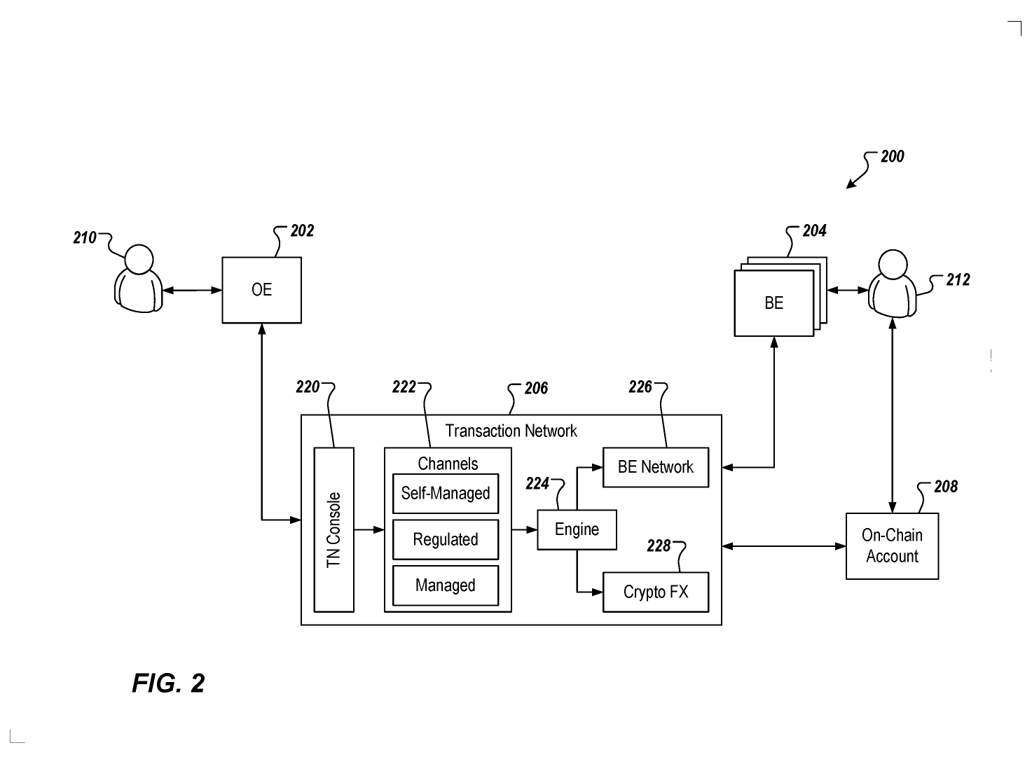

FIG. 2 depicts a conceptual architecture 200 in accordance with implementations of the present disclosure. The example of FIG. 2 includes an originating entity (OE) 202 (e.g., an originating financial institution OFI)), one or more beneficiary entities (BEs) 204 (e.g., beneficiary financial institutions (BFIs)), a transaction network 206 (i.e., the CPN of the present disclosure), an on-chain account 208, a user 210, and a user 212. In some examples, the OE 202 operates an enterprise system (e.g., the enterprise system 108 of FIG. 1) and each of the BEs 204 operates an enterprise system (e.g., the enterprise system 110 of FIG. 1). In some examples, the user 210 operates a user system (e.g., the user system 104 of FIG. 1) and the user 212 operates a user system (e.g., the user system 106 of FIG. 1). In some examples, the transaction network 206 is provided by the provider system 102 using the cryptographic network 112 and the network 114. Although a single OE 202 is depicted, it is contemplated that implementations of the present disclosure can include any appropriate number of OEs 202.

In the example of FIG. 2, the transaction network 206 includes a console 220, a set of channels 222, an engine 224, a BE network module 226, and a crypto FX module 228. In some examples, the console 220 enables the OE 202 to interact with the transaction network 206. In some examples, the set of channels 222 enables transaction flows for disparate types of transactions. In some examples, the engine 224 is configured to provide network operations functionality, network governance functionality, and payment orchestration functionality.

As described in detail herein, the transaction network 206 orchestrates digital asset segments of transactions, which can include, for example and without limitation, minting, custody, accepting digital asset pay-ins and initiating digital asset pay-outs, as well as supporting fiat pay-outs. In some examples, the BE network module 226 enables fiat pay-outs to BEs 204. In some examples, the crypto FX module 228 enables digital asset payouts.

In some examples, the set of channels 222 include a self-managed channel 222a, a regulated channel 222b, and a managed channel 222b. In some examples, the self-managed channel 222a is used by so-called crypto-native OEs. Example crypto-native OEs can include enterprises that regularly operate touching, holding, using digital assets (e.g., stablecoins for transactions). In some examples, the regulated channel 222b is used by so-called crypto-willing enterprises that already hold money-movement licenses, but lack digital asset infrastructure and expertise. In some examples, the managed channel 222c is used by so-called crypto-curious enterprises that prefer an arm’s length relationship to digital (e.g., do not want to implicate their licenses or have cryptocurrency on their balance sheets).

In some examples, the OE 202 interacts with the transaction network 206 includes a console 220. In some examples, the user 210 can interact with the OE 202 to execute a transaction for the benefit of the user 212 through a BE 204 associated with the user 212. For example, the user 210 can initiate the transaction through the OE 202 (e.g., log into a website of the OE 202 to access an account of the user 210 and initiate the transaction). In some examples, the OE 202 interacts with the transaction network 206 through the console 220. Depending on the specifics of the transaction, the transaction network 206 executes the transaction using tokens of a digital asset (e.g., a cryptocurrency, such as a stablecoin). In executing the transaction, the user 212 can receive tokens of the digital asset at the on-chain account 208 (i.e., an account of the user 212 within the cryptocurrency network), and/or receive fiat currency through a BE 204.

In some examples, the transaction network 206 supports a set of primary transaction flows that can include cryptocurrency settlement, cryptocurrency acceptance, and cross-border payments. For example, cryptocurrency settlement can include receiving fiat currency from a user (e.g., the user 210 through the OE 202) and settle with third-party merchants, enterprises, card networks, and the like, in cryptocurrency. As another example, cryptocurrency acceptance can include collecting and receiving cryptocurrency from a user or an enterprise, and off-ramp the cryptocurrency as fiat to a fiat bank account. As another example, cross-border payments can include using cryptocurrency as a bridge digital asset for real-time settlement (e.g., a “stablecoin sandwich”) for cross-border payments terminating in local fiat currency.

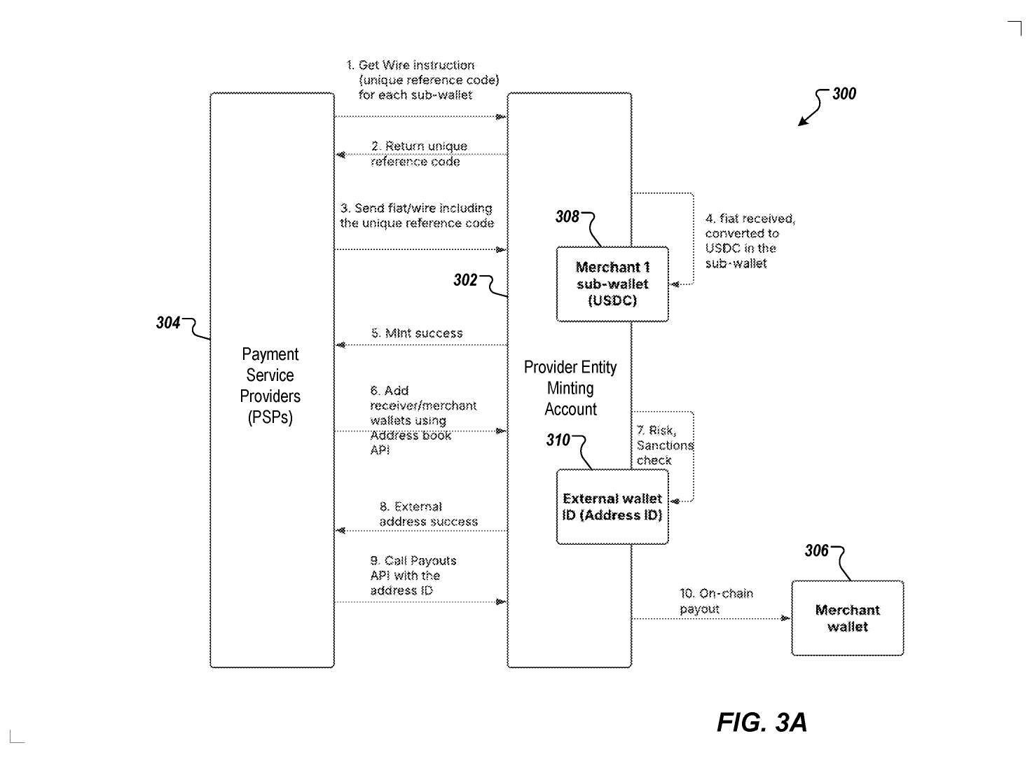

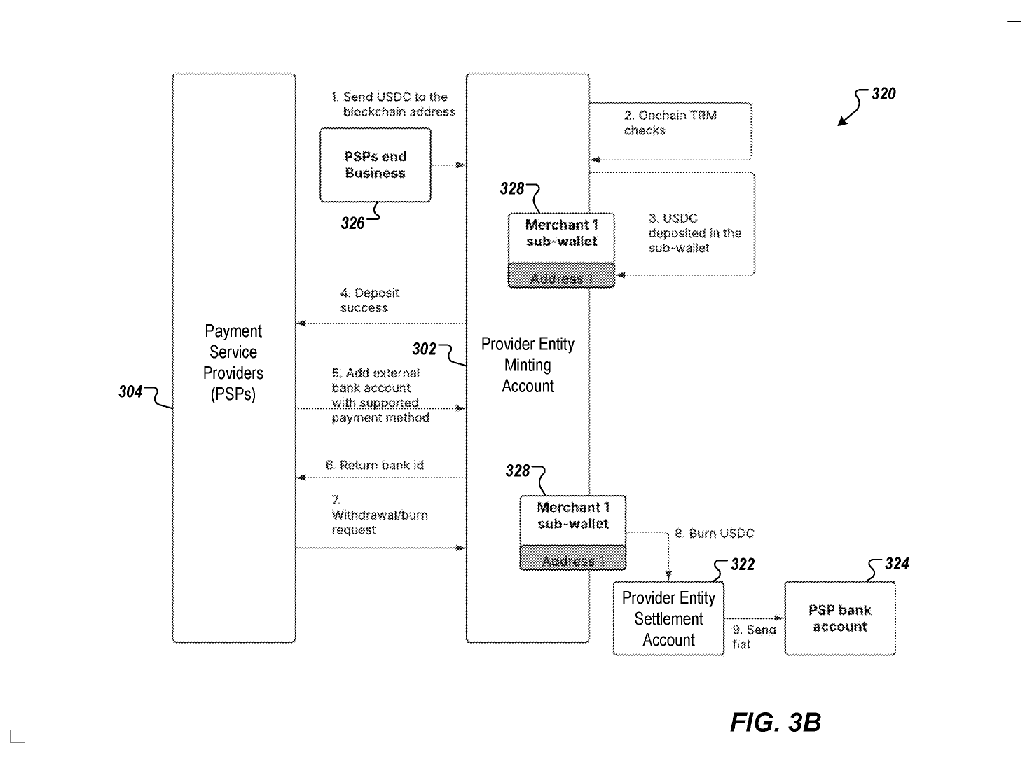

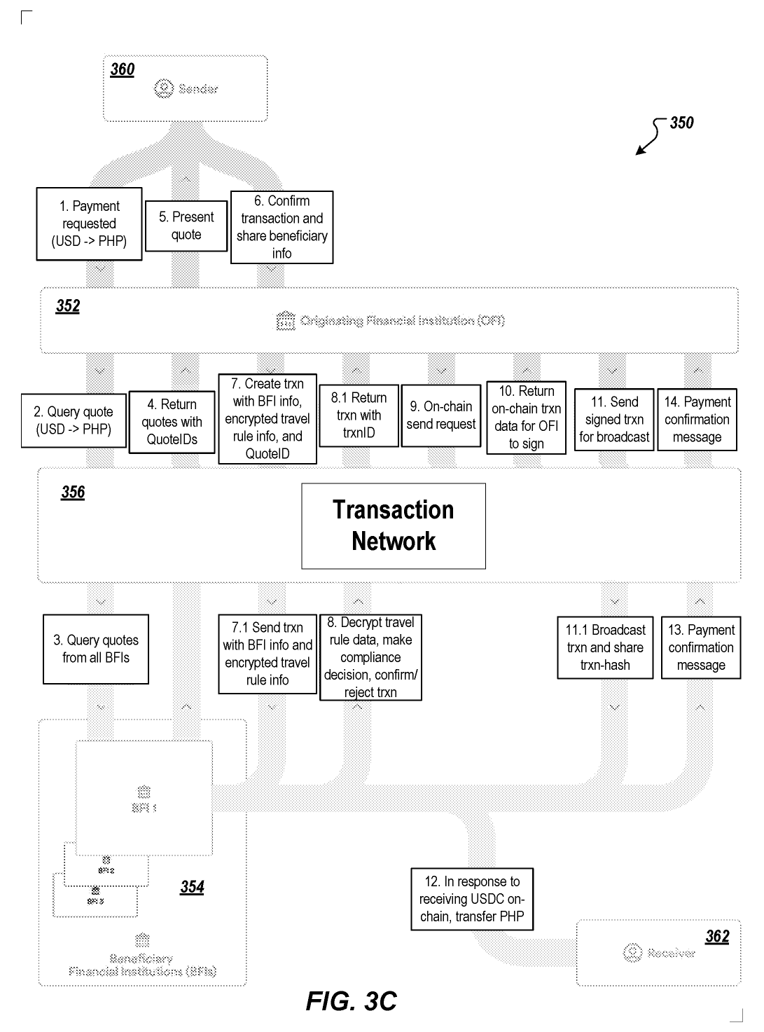

The example transaction flows are described in further detail herein with reference to FIGS. 3A-3C and with non-limiting reference to an example cryptocurrency, namely USDC^{TM}, a stablecoin.

FIG. 3A depicts an example transaction flow 300 for cryptocurrency settlement. The example of FIG. 3A includes a minting account 302 (e.g., of the provider of the provider system 102, the minting account being in the cryptographic network 112 of FIG. 1), one or more PSP systems 304 (e.g., the enterprise system 104, 106 of FIG. 1), and a merchant wallet 306 (on the cryptographic network 112 of FIG. 1). In some examples, the merchant wallet 306 is owned by an enterprise that is to receive cryptocurrency. In the example of FIG. 3A, the provider entity performs regulatory checks (e.g., know-your-business (KYB)) on the PSP and/or the enterprise (merchant). In some examples, tokens of the stablecoin are held in the minting account 302 that is owned by the provider entity. In some examples, sub-wallet 308 is generated for the enterprise (e.g., through institutional APIs). In some examples, in response to receipt of fiat currency, tokens of the stablecoin are minted into the minting account 302. In some examples, on-chain disbursements are executed through the transaction network, which manages all Travel Rule, sanctions, and AML obligations, for example.

FIG. 3B depicts an example transaction flow 320 for cryptocurrency acceptance. The example of FIG. 3B includes the minting account 302, the one or more PSP systems 304, a settlement account 322 (of the provider entity), a PSP bank account 324, and an end business 326 of a PSP. A sub-wallet 328 is provided with the minting account 302. In some examples, the provider entity performs regulatory checks (e.g., KYB) on the PSP and/or the enterprise (merchant). In some examples, tokens of the stablecoin are held in the minting account 302 that is owned by the provider entity. A user triggers a deposits API to create wallet addresses, and deposits tokens of the stablecoin from trusted, whitelisted wallets. The provider entity manages, sanctions, and AML obligations through the transaction network. Received tokens of the stablecoin are burned and fiat is credited to the bank account 324.

FIG. 3C depicts an example transaction flow 350 for cross-border payments (e.g., USD to Philippine Peso). The example of FIG. 3C includes an OFI system 354 (e.g., the OE 202 of FIG. 2), multiple BFI systems 354 (e.g., the BEs 204 of FIG. 2), a transaction network 356 (e.g., the transaction network 206 of FIG. 2), a user 360 (e.g., the user 210 of FIG. 2), and a user 362 (e.g., the user 212 of FIG. 2). In the example of FIG. 3C, the provider entity maintains a designated account within the transaction network 356. The user 360 sends fiat to the provider entity, which mints tokens of stablecoin corresponding to the incoming funds. To orchestrate fiat payout, the transaction network 356 (e.g., the engine 224 and BE network 226 of FIG. 2) is used by the provider entity to route and settle fiat payouts through to complete delivery to the user 362 (end recipient).

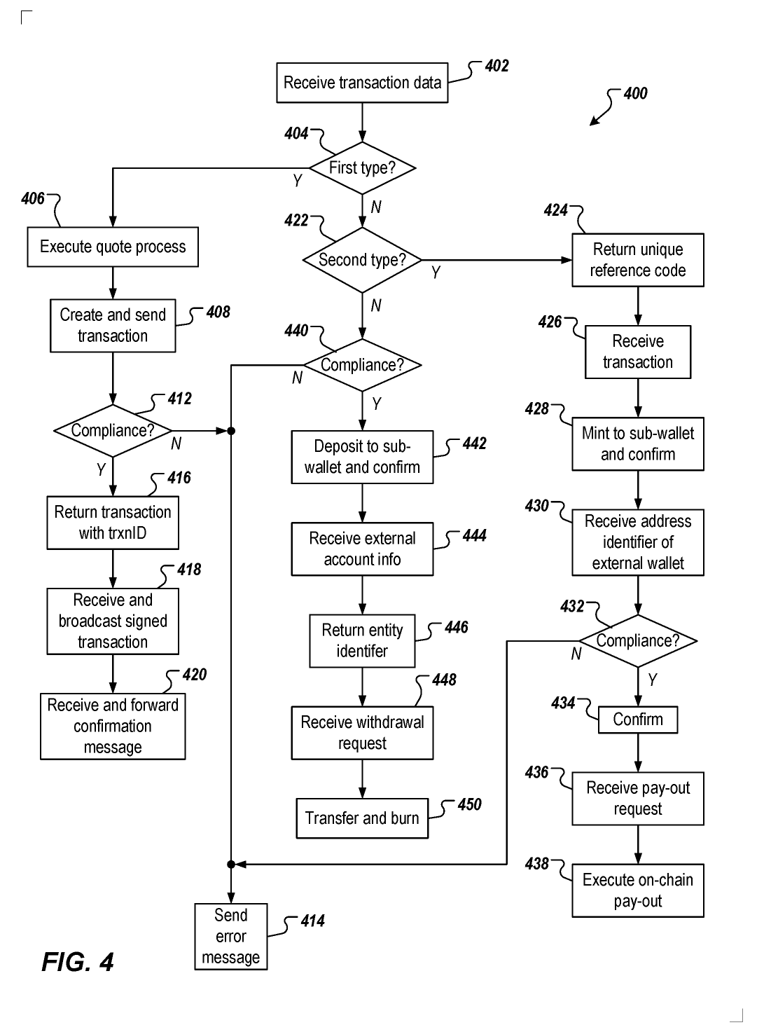

FIG. 4 depicts a flowchart of an example process 400 that can be executed in accordance with implementations of the present disclosure. In some examples, the example process 400 is provided using one or more computer-executable programs executed by one or more computing devices.

Transaction data is received (402). For example, and as described in detail herein, the CPN of the present disclosure (e.g., the transaction network 206 of FIG. 2, the minting account 302 of FIGS. 3A and 3B, the transaction network 356 of FIG. 3C) can receive transaction data from an entity (e.g., the OE 202 of FIG. 2, the PSP 304 of FIGS. 3A and 3B, the OFI 352 of FIG. 3C). In some examples, the transaction data indicates a type of transaction that is being requested. Example transaction types can include, but are not limited to, a cross-border payment (a first type), cryptocurrency acceptance (a second type), and a cryptocurrency settlement (a first type).

It is determined whether the requested transaction is of the first type (404). For example, the transaction network can determined a type of the transaction (e.g., based on the transaction data and/or input to the console 220 of FIG. 2 indicating the transaction type). If it is determined that the transaction is of the first type (cross-border payment), a quote process is executed (406) (e.g., as depicted in FIG. 3C). In some examples, the quote process can include receiving a quote query (e.g., from an OE/OFI) for specified fiat currencies (e.g., USD PHP), querying, by the transaction network, one or more BFIs, and returning quotes with respective quote identifiers. In some examples, the quotes can be presented to a user (e.g., by the OE/OFI), which can select a quote.

A transaction is created and sent (408). For example, the transaction can receive the transaction with beneficiary information (e.g., the user that is intended to receive fiat), encrypted travel rule information, and a quote identifier. The transaction network sends the transaction to the BFI corresponding to the quote identifier. It can be determined whether the transaction meets compliance requirements (412). If the transaction does not meet compliance requirements, an error message is sent (414). For example, the transaction network can send an error message to the OE/OFI to indicating that the transaction failed compliance.

If the transaction meets compliance requirements, the transaction is returned with a transaction identifier (trxnID) (416). For example, the transaction network assigns a unique transaction identifier to the transaction, and returns the transaction with transaction identifier to the OE/OFI. In some examples, the transaction network receives an on-chain send request to request transfer of tokens of a cryptocurrency. This can include, for example, transfer of the tokens of the cryptocurrency in an amount equal to a fiat pay-in of a user (e.g., a sender, such as the user 210 of FIG. 2) from an on-chain account of the OE/OFI. In response to the on-chain send request, the transaction network returns on-chain transaction data for signature. For example, the OE/OFI generates a digital signature for the on-chain transaction using its private key.

A signed transaction is received and is broadcast (418). For example, the transaction network receives the signed transaction from the OE/OFI and broadcasts the signed transaction (e.g., on the cryptocurrency network). In some examples, the transaction is executed within the cryptographic network to transfer the tokens of cryptocurrency from the on-chain account of the OE/OFI to an on-chain account of the BFI (e.g., the BFI whose quote was accepted). In some examples, the transaction is executed in response to verifying the digital signature using the public key of the OE/OFI. In response to the tokens of the cryptocurrency being transferred to the on-chain account of the BFI, the BFI executes a fiat pay-out to an account of a user (e.g., a receiver, such as the user 212 of FIG. 2) and sends a payment confirmation message. The payment confirmation message is received and is forwarded (420). For example, the transaction network receives the payment confirmation message and forward it to the OE/OFI.

If it is determined that the requested transaction is not of the first type (404), it is determined whether the requested transaction is of the second type (422). For example, the requested transaction can request a fiat pay-in indicating a unique reference code associated with a sub-wallet that tokens of cryptocurrency are to be deposited to (e.g., as discussed with reference to FIG. 3A). The unique reference code is returned (424). For example, the transaction network (e.g., the minting account 302 of FIG. 3A) returns the unique reference code to a PSP (e.g., the PSP 304 of FIG. 3A). A transaction is received (426). For example, the transaction network receives the fiat pay-in identified by the unique reference code. In response, tokens of the cryptocurrency are minted, are deposited to the sub-wallet, and a confirmation is returned (428). For example, the minting account of the transaction network mints tokens of the cryptocurrency (e.g., equivalent to the fiat pay-in (minus any fees)), which are deposited to the sub-wallet (e.g., the sub-wallet 308 of FIG. 3A).

An address identifier associated with an external wallet is received (430). For example, the PSP can call an address API to provide the address identifier to the transaction network, which indicates a receiving entity and the external wallet (e.g., the merchant wallet 306 of FIG. 3A). It is determined whether the transaction meets compliance requirements (432). For example, the transaction network can execute one or more regulatory checks based on the address identifier and the receiving entity. If the transaction does not meet compliance requirements, an error message is sent (414).

If the transaction does meet compliance requirements, a confirmation message is provided (434). For example, the transaction network sends a confirmation message to the PSP to indicate that the receiving entity is in compliance. A payout request is received (436). For example, the transaction network receives a payment request from the PSP (e.g., by the PSP calling a payouts API with the address identifier). An on-chain pay-out is executed (438). For example, the tokens of the cryptocurrency are transferred from the sub-wallet to the external wallet within the cryptocurrency network.

If it is determined that the requested transaction is not of the second type, it is determined whether the transaction meets compliance requirements (440). For example, the requested transaction can indicate a wallet address within the cryptocurrency network (e.g., a wallet of the PSP), from which tokens of the cryptocurrency are to be transferred for a fiat pay-out. In some examples, the transaction network can execute one or more regulatory checks (e.g., TRM) based on the wallet address and/or the PSP. If the transaction does not meet compliance requirements, an error message is sent (414).

If the transaction does meet compliance requirements, the tokens of the cryptocurrency are deposited to the sub-wallet and a confirmation message is sent (442). For example, the transaction network sends a confirmation message to the PSP indicating deposit success. External account information is received (444) and an entity identifier is returned (446). For example, the transaction network receives external account information from the PSP, which indicates a fiat pay-out account (e.g., bank account) and the transaction network returns the entity identifier (e.g., bank identifier).

A withdrawal request is received (448) and a transfer and burn are executed (450). For example, the transaction network receives a withdrawal request from the PSP and, in response to the request, transfers a fiat pay-out to the external account, from a settlement account of the provider entity (e.g., the settlement account 322 of FIG. 3B) and burns an equivalent amount of tokens of the cryptocurrency.

As described herein, the CPN (e.g., the transaction network 206 of FIG. 2) of the present disclosure is designed to address a wide range of payment use cases by enabling seamless, efficient, and secure transactions using blockchain networks and stablecoins. The unique architecture and compliance-driven design of the CPN enables, for example, a sender’s financial institution, known as an OFI, to discover the recipient’s financial institution, known as a BFI, on the CPN, and empowers builders to offer innovative payment solutions to individuals, businesses, and other institutions.

For purposes of non-limiting illustration, the CPN is described in further detail with reference to an example use case. The example use case includes end-to-end cross-border payment settlement with the CPN (see, e.g., FIG. 3C).

In the example use case, enterprise payments can be considered. Example enterprise payments can include supplier payments, trade finance, retail payments, payroll and salary disbursements, and use of artificial intelligence (AI) agents.

With regard to supplier payments, the CPN accelerates and simplifies cross-border payments for companies by cutting costs, settlement times, and eliminating intermediaries. For example, a manufacturing company in Mexico needs to pay a steel supplier in Germany, but wants to avoid high FX fees and multi-day bank transfers. The company’s OFI converts MXN to stablecoin (e.g., USDC^{TM}), leverages the CPN to discover BFIs, in Germany and sends USDC, who then seamlessly converts the stablecoin to EUR and settles the payment instantly into the supplier’s account.

With regard to trade finance, the CPN streamlines and secures international trade payments. For example, a U.S. textile importer places an order with an Indian manufacturer, and wishes to minimize traditional trade finance timelines and costs. The importer’s OFI converts USD to stablecoin and, through the CPN, connects with and transfers stablecoin to a BFI in India. The BFI holds the stablecoin in escrow, verifying shipment documents before settling INR to the manufacturer. This ensures faster settlement, lower costs, and reduced counterparty risk, while tapping the innovation of smart contracts for escrow services.

With regard to retail payments, the CPN elevates global online commerce with secure, efficient, and versatile payment options. For example, a fashion retailer in Brazil sells to U.S. customers. The retailer’s BFI discovers an OFI via CPN to collect USD payments. The OFI converts the USD into stablecoin and sends it to the BFI, who then seamlessly exchanges the stablecoin for local BRL, or holds the stablecoin with a digital asset custodian on behalf of the retailer, who receives funds instantly and at a lower cost compared to traditional payment processors, with the option of keeping working capital in digital dollars.

With regard to payroll and salary disbursements, the CPN enables companies to process salary payments globally with minimal fees and instant settlements. For example, a multinational company pays remote employees across multiple countries. Instead of relying on costly, slow traditional banking channels, it relies on its OFI to convert local currency to stablecoin and distributes salaries instantly to employees’ BFIs discovered through the CPN, enabling workers to receive payments seamlessly in their preferred currency.

With regard to AI agents, the CPN enables autonomous AI agents to send and receive payments on behalf of users or systems, supporting real-time value exchange. For example, a logistics company uses AI agents to book freight services across borders. When an agent selects a provider in Singapore, it uses a CPN-integrated OFI to convert USD to stablecoin and automatically sends the payment to a BFI in Singapore, which off-ramps the stablecoin to SGD. The entire payment flow is executed programmatically using smart contracts—minimizing manual steps and enabling intelligent, cross-border machine-to-machine payments.

In the example use case, consumer payments can be considered. Example consumer payments can include remittances, subscriptions, micropayments and content monetization, and e-commerce.

With regard to remittances, the CNP empowers individuals with fast, cost-effective remittance services that avoid high fees and delays. For example, a user in the United States wishes to send money to a family member in the Philippines. The remittance company, an OFI in the U.S., converts USD to stablecoin and simultaneously transfers the stablecoin to a local BFI in the Philippines, dynamically discovered through the CPN, to deliver PHP to the family member in near real-time and at a fraction of traditional remittance fees.

With regard to subscriptions, the CPN supports recurring payments for digital services with programmable, stablecoin-based billing. For example, a digital media platform offers premium subscriptions to users worldwide. Each month, a user’s wallet initiates a stablecoin payment through an OFI, which routes the payment to the platform’s BFI using the CPN. The BFI receives the stablecoin, converts the stablecoin to local fiat if needed, and credits the media platform.

With regard to micropayments and content monetization, the CPN supports content creators and digital services with instant, low-cost micropayments. For example, a content writer in Brazil uses a CPN-enabled BFI to receive micro-donations from followers worldwide by transacting with OFIs, discovered via CPN, local to the followers. Instead of waiting for long settlement times and incurring high platform fees, followers and supporters send stablecoin donations instantly, providing direct, low-cost monetization for the creator.

With regard to e-commerce, the CPN expands consumer access to global online marketplaces with fast and cost-effective payment experiences. For example, a customer in the U.K. purchases electronics from a seller in South Korea through an international e-commerce platform. At checkout, the customer pays in GBP via a local OFI, which converts the funds into stablecoin and transfers the stablecoin to a BFI in Korea. The BFI off-ramps the stablecoin to KRW and deposits it into the seller’s account or holds it as with a digital asset custodian on behalf of the seller.

In the example use case, institutional payments can be considered. Example institutional payments can include capital markets settlement, FX, treasury services, government and humanitarian payments, and DeFi integrations.

With regard to capital markets settlement, the CNP improves trading by enabling faster, transparent settlements between financial institutions, reducing counterparty risks and operational costs. For example, a U.S. asset manager executes an OTC bond trade with a European investment bank, but wants to avoid T+2 settlement delays, with related capital inefficiencies and counterparty risks. The asset manager’s OFI converts USD to stablecoin and, leveraging the CPN, connects with and transfers stablecoin to a BFI in Europe that instantly settles the transaction in EUR for the investment bank.

With regard to FX, the CPN simplifies currency conversion by making multi-currency operations efficient and cost-effective, addressing challenges such as expensive foreign exchange rates from traditional providers and the complexity and delays of multi-currency management. For example, a European investment firm wishes to fund a real estate acquisition in Japan, avoiding high FX fees and delays. The OFI for the investment firm converts EUR to stablecoin, which a BFI in Japan receives and seamlessly exchanges for JPY at a competitive FX venue on-chain and settles instantly.

With regard to treasury services, the CPN simplifies fund repatriation by enabling efficient conversion of foreign-earned revenue back to a company’s home market. For example, a U.S. based enterprise software provider licenses cloud-based solutions to businesses across Southeast Asia. To repatriate revenue from the region, the company’s BFI in the U.S. uses the CPN to discover a local OFI in the Philippines. The OFI collects PHP payments from enterprise clients, converts the funds into stablecoin, and transmits the stablecoin to the U.S. based BFI. The BFI then off-ramps the stablecoin into USD and deposits it into the company’s treasury account—enabling faster, cost-effective, and compliant global revenue consolidation.

With regard to government and humanitarian payments, the CPN provides a secure, reliable and efficient channel for large-scale disbursements—from disaster relief funds to institutional transfers. For example, an international NGO distributes disaster relief funds using stablecoins. The NGO initiates the payment through its OFI, which converts local fiat into stablecoin and transfers the stablecoin to a BFI operating in the recipient’s region. The BFI then either delivers the funds directly to recipients’ digital wallets or off-ramps the stablecoin into local fiat and deposits it into their bank accounts, ensuring transparency, accelerating fund delivery, and enhancing accountability for aid disbursements.

With regard to DeFi integrations, the CPN supports DeFi innovators by providing a foundation for lending, borrowing, saving, and more, unlocking the power of on-chain finance at mainstream scale. For example, a duly licensed and regulated DeFi lending platform integrates stablecoin to offer loans and savings products. With CPN’s infrastructure, the platform can facilitate seamless cross-border transactions, reduce volatility, and support compliant institutional customer flows, while building trust among a diverse user base.

As described herein, the ecosystem of the CPN includes key stakeholders and participants, each playing a role in facilitating global payments and advancing technology innovation while driving network governance, economic value creation and network adoption. Examples includes a governing body of the CPN, members of the CPN, end users of the CPN, and service providers of the CPN.

In some examples, the governing body of the CPN can include an entity (the provider entity) that provisions the stablecoins used within the CPN. In some examples, the governing body of the CPN sets standards and functions as the operator of the CPN. Responsibilities of the governing body of the CPN can include:

Develop and maintain core infrastructure—smart contracts, APIs, and SDKs—for seamless payment settlement of send/receive transactions across blockchain networks.

Operate the coordination layer for member and price discovery, payment routing and settlement between counterparties

Facilitate standardized and automated information sharing between Members to enable compliance with Travel Rule.

Establish and maintain the CPN rules that govern eligibility, operations, and compliance for all participants.

Verify the eligibility of financial institutions, approve their participation in the network, and issue credentials confirming adherence to CPN standards for licensing, AML/CFT, sanctions compliance, and financial strength.

Oversee member compliance with regulatory requirements, including AML/CFT and sanctions, through ongoing risk-based reviews.

Plan and manage network security, incident response, and infrastructure to ensure operational integrity and resilience.

Onboard pre-vetted third-party service providers and modular applications that meet CPN’s compliance, security, and performance standards

In some examples, members of the CPN, also known as Participating Financial Institutions (PFIs), serve as counterparties that originate, facilitate, or receive payments across the network and execute transactions in compliance with CPN rules and governance standards. PFIs include financial institutions, such as Virtual Asset Service Providers (VASPs), both traditional and crypto-native PSPs, as well as conventional and digital banks. Depending on their role in a transaction, PFIs may act as either OFIs, which initiate payments on behalf of senders, or BFIs, which receive payments and facilitate last-mile fiat off-ramping and stablecoin custody to beneficiaries. CPN members’ responsibilities can include:

Maintain proper licensing and ensure ongoing compliance with applicable regulations, including AML/CFT and sanctions, across all relevant jurisdictions as well as adherence to CPN rules.

Participate in an eligibility process and maintain up-to-date verification of legal entity information, compliance posture, jurisdictional scope, and risk profile.

Perform risk-based evaluation of counterparties and transactions as per their compliance obligations, leveraging information collected and oversight performed through CPN.

Execute payments through a suite of technology services and protocols, as detailed in the following section, based on their role as an OFI or BFI.

Adhere to CPN’s technical and infrastructure requirements, including secure integration, SLA performance, transaction monitoring, and data protection protocols.

Share required originator and beneficiary information, in accordance with CPN’s compliance framework for Travel Rule, requests for information (RFIs), and other oversight requests.

Monitor transactions to detect and report suspicious activity in accordance with applicable regulations.

Contribute to CPN governance through structured feedback, operational reviews, and member reputation scoring to enhance transparency and support continuous improvement.

Provide timely support and resolution for network inquiries from other members or end users.

Develop and deliver innovative payment use cases by leveraging CPN’s developer SDKs, regulated stablecoins and smart contract infrastructure.

In some examples, end users (e.g., enterprises, individuals) can be described as the ultimate senders and beneficiaries of payment transactions—while they do not directly interact with the CPN, they benefit from lower costs, faster settlements, greater transparency and ongoing innovation, with senders initiating payments via an OFI and beneficiaries receiving payments through a BFI.

In some examples, service providers can include financial institutions (FI) and non-financial institutions (Non-FI), offer value-added technology solutions and financial services to CPN members and end users. Example service providers can include liquidity providers and FX venues, stablecoin issuers, and technology solution and financial services providers. In some examples, liquidity providers and FX venues facilitate efficient market-making, price discovery, and currency conversion for stablecoin transactions within the CPN and/or provide liquidity for cross-border stablecoin settlements and ensure competitive FX rates. In some examples, stablecoin issuers issue regulated fiat-backed digital currencies (payment stablecoins) that serve as the primary medium of exchange within the CPN. Stablecoin issuers ensure transparent reserves, regulatory compliance, and underlying fiat liquidity for seamless cross-border transactions. In some examples, technology solution and financial services providers equip CPN members with a range of services such as fraud and risk management, wallet infrastructure, custody solutions, billing and invoicing, and compliance and transaction monitoring solutions, supporting their business and operational needs.

With regard to governance, eligibility, and network operations, the CPN operates under a collaborative and transparent governance framework designed to prioritize compliance, security, and trust within the network. The framework covers multiple aspects of governance that can include eligibility review and oversight, network functionality and operations, and transparency and stakeholder engagement.

With regard to eligibility review and oversight, the governing body of the CPN is responsible for setting stringent eligibility standards as detailed in the CPN rules and facilitating the integration of regulated payment stablecoins into the network. The CPN governance framework of the CPN defines the eligibility standards, credentialing protocols, and integration of regulated stablecoins to ensure trusted participation across the network—for financial institutions, regulated stablecoin issuers, and service providers alike.

Members must meet comprehensive eligibility requirements before being granted access to the network. This includes holding all necessary licenses, implementing sanctions and AML programs aligned with local regulations and global norms, maintaining reasonable security controls, and demonstrating sufficient financial strength. As the network operator, the governing body evaluates all prospective members before enabling access and periodically reevaluates them based on risk. Members licensed under robust regulatory regimes, as established by international compliance standard-setting bodies such as FATF, are subject to standard reviews, while others are subject to more in depth evaluations. Eligibility standards are published, and assessments of the governing body may also serve as inputs to members’ own counterparty diligence processes.

The CPN issues unique network credentials to eligible members upon successful eligibility verification and approval. Credentials enable counterparties to identify each other and retrieve counterparty information in a secure manner, promoting transparency, facilitating informed risk assessments, and increasing the efficiency of counterparty due diligence. This credential captures a defined set of attributes—including membership status, jurisdictional scope, and eligibility information—which are continuously monitored and updated to reflect changes in risk posture.

The governance framework of the CPN outlines a structured evaluation and approval process for integrating new regulated payment stablecoins into CPN. Prospective stablecoins must undergo rigorous assessments against CPN’s stringent eligibility standards, including factors such as regulatory compliance, transparent reserves and attestations, banking rail availability, underlying fiat liquidity, risk management standards, information and cybersecurity capabilities, and reporting practices. Only stablecoins that fully satisfy these criteria and receive approval from the governing body may operate within the network, ensuring they contribute to a stable, secure, and efficient network ecosystem.

With regard to network functionality and operations, the core functionality of the CPN enables seamless, compliant transactions, but also ensures operational rigor, and ongoing improvement. The CPN empowers members to conduct secure, real-time transactions through a robust operational framework that ensures consistency, scalability, and resilience. This framework includes transaction orchestration, operational support, incident response, and infrastructure management.

Transactions within the CPN are orchestrated through a suite of technology services and protocols, as detailed in the following section, ensuring seamless execution between participating members. Additionally, network members continuously monitor transaction flows using automated alerts provided by the CPN, along with periodic risk assessments focused on transaction anomalies, partner performance—such as evaluating failed transaction rates, service-level agreement (SLA) breaches. Together, these measures proactively mitigate operational risks and help preserve the reliability and efficiency of the network.

The CPN provides well-defined operational guidelines, including SLAs as defined in the CPN rules, that include expectations for uptime, transaction speed, dispute resolution, and timely information sharing. The CPN also standardizes the exchange of transactions and counterparty data to streamline operations by reducing the need for bespoke coordination.

The CPN maintains detailed protocols for managing security incidents, regulatory compliance issues, and system outages. These include pre-defined communication channels with members and a transparent, impartial resolution process, ensuring swift action and effective dispute management, whether related to compliance or transactional issues. The infrastructure of the CPN is continuously monitored through observability tools that track throughput, latency, and error rates. Automated performance monitoring and routine load testing allow the network to scale in response to demand. Ther governing body works with vetted infrastructure and cloud partners to ensure elastic compute and storage provisioning. Scalability reviews and corridor-level stress tests validate readiness for growing volumes and network expansion.

With regard to transparency and stakeholder engagement, by actively engaging diverse stakeholders—including financial institutions, regulators, businesses, and builders—the CPN aligns with global standards to foster trust, accelerate adoption, and promote sustainable network ecosystem growth. Governance of the CPN is built on transparency, fostering trust and confidence among all participants. The governing body, with input from advisory committees, acts on strategic recommendations that strengthen the governance framework. Regular surveys, focus groups, and structured reviews can be conducted to capture member feedback and assess service quality. These inputs drive continuous improvement and help ensure the network evolves to meet participant needs. Independent audits and periodic public reports on transaction volumes, system uptime, and member compliance further reinforce operational integrity and accountability.

CPN member and end-user representation, along with regulatory engagement, play a vital role in the evolution of the CPN. CPN members are encouraged to actively contribute to the development of network rules and technical standards by offering recommendations and operational insights that help shape the network’s strategy and growth. Additionally, a financial services arm of the governing body brings a strong track record of ongoing engagement with global regulatory bodies—an asset that can be leveraged to ensure CPN remains aligned with international standards—particularly international AML/CFT and FATF Travel Rule standards—and operates in a secure, trusted, and compliant environment.

As described herein, the CPN serves as a coordination layer that is purpose-built for stablecoins, enabling seamless, compliant, and programmable global transactions. The CPN leverages public blockchain networks for final settlement while optimizing payment orchestration, compliance-related data exchange, and intelligent routing across payment stablecoins and network members. Stablecoins serve as the foundational digital asset class within the CPN, providing the stability, interoperability, and programmability required for high-trust financial applications. The CPN can extend support to any regulated payment stablecoins that meet CPN’s rigorous governance and eligibility standards. Over time, CPN will serve as a foundation for builders to develop interoperable modules and app services that expand the CPN’s utility and unlock new use cases for global payments and financial innovation.

The payment protocol of the CPN is built on a hybrid architecture that combines off-chain and on-chain systems to help aggregate liquidity and facilitate price discovery among network members. As additional payment stablecoins join the CPN, the CPN will evolve into an on-chain FX routing infrastructure, enabling efficient and instant stablecoin-to-stablecoin exchanges while still orchestrating transaction settlements between the OFIs and BFIs.

In an initial iteration of the CPN, orchestration occurs through off-chain API systems that generate transaction objects. These transaction objects are then signed by the OFI to initiate the stablecoin transfer to the corresponding BFI. At this stage, the network operator (governing body), broadcasts all transactions to the appropriate blockchain. This process validates payment information—confirming that the correct amount and tokens are sent to the BFI and that all associated fees are covered within the agreed upon settlement timeframe.

Subsequently, the CPN will transition to a smart contract protocol architecture, enhancing network composability and introducing more efficient, value-added features. The Smart Contract Payment Protocol of the CPN functions to orchestrate seamless, on-chain payments between network members using stablecoins. By leveraging smart contracts, the protocol would enable transactions with minimized risk of errors, automated reconciliation, and efficient fee collection while maintaining a non-custodial design. Under this protocol, OFIs initiate payments through a smart contract deployed on the supported public blockchain networks. The contract validates key transaction parameters—such as token type, amount, recipient address, and deadline—before executing the payment. Unlike traditional transfers, which are prone to errors and require separate invoicing for transaction fees, the smart contract enforces precise payments and routes transactions efficiently across different BFIs in scenarios involving multiple bids and quotes.

To enhance transparency and security, each transaction is uniquely identified and timestamped, ensuring clear auditability for compliance and reconciliation purposes. Additionally, the protocol can include an optional “undo” feature, allowing senders a brief window to cancel erroneous transactions before finalization.

In some implementations, FX is optimized through intelligent discovery and routing. For example, the CPN enables participating FIs to discover providers and to send stablecoins for payment settlement. For discovery, the CPN allows for an OFI to query the network for a given stablecoin or fiat pair. The CPN enables the OFI to discover the network participants and the corresponding price and liquidity available for the request. Initially, the stablecoin is integrated with local fiat liquidity order books and private liquidity sources. The CPN can be provided as a fully on-chain architecture for FX routing, aggregation and settlement—providing direct access to on-chain FX pools, order books, and private liquidity. The discovery capability of the CPN will include order routing and the Request-for-Quote (RFQ) system will further optimize FX execution to meet the performance standards of traditional payment systems.

While the CPN initially focuses on discovering liquidity across BFIs, it will evolve to include whitelisted on-chain venues—such as Automated Market Makers (AMMs), on-chain order books, and other liquidity providers—to expand access to stablecoin liquidity. Once discovered, the CPN intelligently matches orders across these sources, enabling direct stablecoin FX swaps with built-in safeguards and transparent execution, coordinated by the network operator.

The CPN settles payments seamlessly across chains. The CPN enables native settlement of stablecoins across multiple blockchains, offering a seamless mechanism for cross-chain payment transfers. PFIs bring their preferred blockchains to the network, while the CPN orchestrates transactions between the selected source and destination blockchains for efficient payment settlement. Leveraging a cross-chain transfer protocol, the CPN enables fast and secure cross-chain transfers for allowed stablecoins, ensuring transactions retain both speed and integrity across blockchain networks. Initially, the platform will support a limited number of chains at launch, with future expansion to additional blockchains driven by network members’ preferences.

The CPN preserves confidentiality with selective transparency the CPN will incorporate advanced confidentiality-enhancing features on public blockchains to protect transactional data designed to assist members with meeting their privacy and operational obligations. These mechanisms enable users to designate certain transactions as confidential, ensuring that sensitive payment information is not permanently visible on a public blockchain. This capability supports a broad range of applications, allowing businesses to maintain confidentiality for critical activities such as business payments, trade finance, and payroll processed through the CPN. Additionally, the CPN employs a confidentiality protocol to enable selective disclosure. Under this protocol, transaction details will be accessible only to authorized parties, including transacting counterparties, law enforcement, regulators and auditors, and solely when required for compliance or legal purposes.

Further, capabilities can be expanded through composability and trusted interoperability. For example, to expand the value of the network ecosystem, the CPN enables pre-vetted third-party protocols to integrate and interoperate with its core infrastructure, enhancing the utility and versatility of its payment capabilities. A diverse range of integrations can be provided including protocols for lending and credit, liquidity aggregation, institutional yield, escrow, subscription services, and more. Participation is limited to protocols that have been whitelisted, audited, and rigorously vetted by the governing body, meeting stringent standards for regulatory compliance, security, and liquidity management. Through this composable architecture, the CPN aims to unlock a secure, programmable foundation and third-party ecosystem for global payments, financial services, and technology-driven solutions.

Economic models and incentives of the CPN have been crafted to drive rapid early adoption while establishing a sustainable, long-term revenue strategy for all network members. It aligns incentives across network members, end users, builders, and service providers to encourage network growth and sustainability. Transactions processed through the CPN incur: Payout Fees, which compensate BFIs for local fiat disbursement and processing; FX Spreads, reflecting liquidity risk and conversion costs; and a CPN Network Fee—a variable basis-point charge, tiered by country group—to support core network functions including compliance, security, infrastructure, and development.

As the CPN grows and new value-added services are introduced by the governing body and third-party developers via a curated marketplace, additional usage-based fees will be implemented to support and sustain these offerings. These services may include tools for fraud detection, risk management, wallet infrastructure, escrow, billing, and advanced compliance capabilities. First-party (1P) and third-party (3P) service fees will create revenue opportunities for providers and enable financial institutions to tailor payment experiences through modular, plug-and-play offerings.

A portion of network and marketplace fees will be strategically reinvested into core priorities, such as infrastructure upgrades, R&D, network operations, user acquisition incentives, and developer ecosystem growth—including grants for CPN integrations and new applications. This reinvestment approach is designed to strengthen platform resilience, drive innovation, and accelerate long-term network expansion.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device (e.g., a smartphone that is running a messaging application), and receiving responsive messages from the user in return.

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for digital asset transaction orchestration using cryptocurrency networks, comprising:
receiving, by a transaction network, a first set of transaction data; and
determining that the first set of transaction data is associated with a first type of transaction, and in response:
transmitting, by the transaction network, at least a portion of the first set of transaction data to a beneficiary entity associated with a quote identifier provided in the first set of transaction data, and
receiving, by the transaction network, a transaction confirmation, and in response:
receiving an on-chain send request,
returning on-chain transaction data for signature,
receiving a signed transaction,
broadcasting the signed transaction, and
receiving a transaction confirmation message confirming that a transaction has been executed, the transaction at least partially comprising converting tokens of a cryptocurrency to a first amount of a first fiat currency.

2. The method of claim 1, wherein the first set of transaction data comprises beneficiary data that is representative of the beneficiary entity of a plurality of beneficiary entities.

3. The method of claim 1, wherein the transaction further comprises converting an amount of a second fiat currency to the tokens of the cryptocurrency.

4. The method of claim 1, further comprising:
receiving, by the transaction network, a second set of transaction data; and
determining that the second set of transaction data is associated with a second type of transaction, and in response:
transmitting, by a minting account of the transaction network, a unique identifier associated with the second set of transaction data,
receiving an amount of a fiat currency associated with the unique identifier,
providing a set of tokens of the cryptocurrency to a sub-wallet associated with the transaction network within the cryptocurrency network,
receiving, by the transaction network, an address identifier associated with an external wallet within the cryptocurrency network, and
transferring, by the transaction network, an on-chain payout of at least a sub-set of the set of tokens of the cryptocurrency to the external wallet.

5. The method of claim 4, wherein the transaction network executes one or more regulatory checks associated with an entity that owns the external wallet, and the on-chain payout is executed at least partially in response to determining compliance with the one or more regulatory checks.

6. The method of claim 4, wherein the transaction network executes the on-chain payout in response to an application programming interface (API) call comprising the address identifier.

7. The method of claim 1, further comprising:
receiving, by the transaction network, a third set of transaction data; and
determining that the third set of transaction data is associated with a third type of transaction, and in response:
depositing, by the transaction network, a set of tokens of the cryptocurrency to a sub-wallet associated with the transaction network within the cryptocurrency network, and
receiving, by the transaction network, a withdraw request associated with an entity identifier, and in response:
burning at least a sub-set of the set of tokens of cryptocurrency within the cryptocurrency network.

8. The method of claim 7, further comprising receiving the set of tokens of the cryptocurrency from an on-chain account within the cryptocurrency network, wherein the transaction network executes one or more regulatory checks associated with an entity that is associated with the on-chain account, and deposits the set of tokens of the cryptocurrency to the sub-wallet at least partially in response to the one or more regulatory checks.

9. The method of claim 7, further comprising:
in response to depositing, by the transaction network, the set of tokens of the cryptocurrency to a sub-wallet, transmitting a deposit success message to an enterprise system; and
receiving, by the transaction network, a request to add an external account, and in response:
returning the external identifier to the enterprise system.

10. A non-transitory computer-readable storage medium coupled to one or more processors and having instructions stored thereon which, when executed by the one or more processors, cause the one or more processors to perform operations for digital asset transaction orchestration using cryptocurrency networks, the operations comprising:
receiving, by a transaction network, a first set of transaction data; and
determining that the first set of transaction data is associated with a first type of transaction, and in response:
transmitting, by the transaction network, at least a portion of the first set of transaction data to a beneficiary entity associated with a quote identifier provided in the first set of transaction data, and
receiving, by the transaction network, a transaction confirmation, and in response:
receiving an on-chain send request,
returning on-chain transaction data for signature,
receiving a signed transaction,
broadcasting the signed transaction, and
receiving a transaction confirmation message confirming that a transaction has been executed, the transaction at least partially comprising converting tokens of a cryptocurrency to a first amount of a first fiat currency.

11. The non-transitory computer-readable storage medium of claim 10, wherein the first set of transaction data comprises beneficiary data that is representative of the beneficiary entity of a plurality of beneficiary entities.

12. The non-transitory computer-readable storage medium of claim 10, wherein the transaction further comprises converting an amount of a second fiat currency to the tokens of the cryptocurrency.

13. The non-transitory computer-readable storage medium of claim 10, wherein operations further comprise:
receiving, by the transaction network, a second set of transaction data; and
determining that the second set of transaction data is associated with a second type of transaction, and in response:
transmitting, by a minting account of the transaction network, a unique identifier associated with the second set of transaction data,
receiving an amount of a fiat currency associated with the unique identifier,
providing a set of tokens of the cryptocurrency to a sub-wallet associated with the transaction network within the cryptocurrency network,
receiving, by the transaction network, an address identifier associated with an external wallet within the cryptocurrency network, and
transferring, by the transaction network, an on-chain payout of at least a sub-set of the set of tokens of the cryptocurrency to the external wallet.

14. The non-transitory computer-readable storage medium of claim 13, wherein the transaction network executes one or more regulatory checks associated with an entity that owns the external wallet, and the on-chain payout is executed at least partially in response to determining compliance with the one or more regulatory checks.

15. The non-transitory computer-readable storage medium of claim 13, wherein the transaction network executes the on-chain payout in response to an application programming interface (API) call comprising the address identifier.

16. A system, comprising:
one or more processors; and
a non-transitory computer-readable storage device and having instructions stored thereon which, when executed by the computing device, cause the computing device to perform operations for digital asset transaction orchestration using cryptocurrency networks, the operations comprising:
receiving, by a transaction network, a first set of transaction data; and
determining that the first set of transaction data is associated with a first type of transaction, and in response:
transmitting, by the transaction network, at least a portion of the first set of transaction data to a beneficiary entity associated with a quote identifier provided in the first set of transaction data, and
receiving, by the transaction network, a transaction confirmation, and in response:
receiving an on-chain send request,
returning on-chain transaction data for signature,
receiving a signed transaction,
broadcasting the signed transaction, and
receiving a transaction confirmation message confirming that a transaction has been executed, the transaction at least partially comprising converting tokens of a cryptocurrency to a first amount of a first fiat currency.

17. The system of claim 16, wherein the first set of transaction data comprises beneficiary data that is representative of the beneficiary entity of a plurality of beneficiary entities.

18. The system of claim 16, wherein the transaction further comprises converting an amount of a second fiat currency to the tokens of the cryptocurrency.

19. The system of claim 16, wherein operations further comprise:
receiving, by the transaction network, a second set of transaction data; and
determining that the second set of transaction data is associated with a second type of transaction, and in response:
transmitting, by a minting account of the transaction network, a unique identifier associated with the second set of transaction data,
receiving an amount of a fiat currency associated with the unique identifier,
providing a set of tokens of the cryptocurrency to a sub-wallet associated with the transaction network within the cryptocurrency network,
receiving, by the transaction network, an address identifier associated with an external wallet within the cryptocurrency network, and
transferring, by the transaction network, an on-chain payout of at least a sub-set of the set of tokens of the cryptocurrency to the external wallet.

20. The system of claim 19, wherein the transaction network executes one or more regulatory checks associated with an entity that owns the external wallet, and the on-chain payout is executed at least partially in response to determining compliance with the one or more regulatory checks.
